(19) United States
(12) Patent Application Publication
(10) Pub. No.: US 2026/0139975 A1
(43) Pub. Date: May 21, 2026

(54) PIPE FITTING WITH SENSOR

(71) Applicant: LenLok Holdings, LLC, Willoughby, OH (US)

(72) Inventors: Mark John SINDELAR, Shaker Heights, OH (US); Alan Michael PEABODY, Willougby, OH (US); Mark LEOPOLD, Solon, OH (US); Dan MAHER, Solon, OH (US); Mark TIMIESKI, Solon, OH (US)

(21) Appl. No.: 19/452,632

(22) Filed: Jan. 19, 2026

Related U.S. Application Data
(60) Provisional application No. 63/705,762, filed on Oct. 10, 2024.

(51) Int. Cl. G01D 11/24; H01Q 1/22; H02S 20/20

(52) U.S. Cl. CPC G01D 11/245; H01Q 1/2291; H02S 20/20

(57) ABSTRACT

A sensor device for a fluid fitting, including a sensor assembly that is operable to measure a physical property of the fluid fitting and an antenna that is operable to wirelessly transmit the physical property measured by the sensor assembly. A solar panel is configured to convert light to electrical energy for the sensor and antenna. The sensor device is configured such that the antenna can wirelessly transmit the physical property measured by the sensor assembly while the solar panel simultaneously converts light to electrical energy for the sensor assembly and antenna.

### CROSS-REFERENCE TO RELATED APPLICATION

This application claims the benefit of U.S. provisional application 63/705,762, filed on Oct. 10, 2024, the contents of which is incorporated herein by reference.

### BACKGROUND

Generally, one type of fitting for fluid conduits, such as tubes or pipes, includes a connector body that fits loosely over the fluid conduit and a drive ring which compresses and/or physically deforms the connector body against the outside surface of the fluid conduit to provide one or more seals and to provide a strong mechanical connection.

Conventionally, various physical inspection tests have been developed to confirm a proper installation of the fluid fitting upon the pipe. For example, various visual tests are used to ensure that the fitting is properly aligned and positioned upon the pipe. Other invasive or non-invasive tests can be done, such as ultrasonic tests, X-rays, or the like. However, these types of tests are typically only useful at the actual time of installation, and may only provide indirect evidence that the fitting is properly installed upon the pipe.

Moreover, these tests in particular do not offer continuing information about the state of the fitting over its useful lifetime. Often, these fluid fittings are used in harsh and sour environments in the presence of corrosive process fluids or gases, such as Hydrogen Sulfide. For example, H₂S in the presence of water can result in damage to carbon steel pipelines in the form of corrosion, cracking, or blistering. The effects of H₂S on steel can result in sulphide stress cracking (SSC), hydrogen induced cracking (HIC), and corrosion. The presence of carbon dioxide in the sour environment tends to increase the corrosion rate in the steel. It may also increase the susceptibility of the steel to both SSC and HIC. These effects can jeopardize the fluid fitting and pipe.

U.S. patent application Ser. No. 18/068,789 describes an RFID sensor device that can be attached to a fluid fitting and operated to provide information about the state of the fluid fitting at the time of installation upon the pipe, as well as continuing information over the useful lifetime of the fitting. In particular, the sensor device receives electrical power via RF signals from an RFID reader, and uses that electrical power to measure strain of the fluid fitting. The sensor device then transmits RF signals back to the RFID reader to communicate those measurements.

That sensor device has an antenna that enables the device to communicate with the RFID reader. However, the antenna cannot transmit and receive RF signals simultaneously. Accordingly, in some embodiments, the sensor device executes a duty cycle in which RF signals are received from the RFID reader for half of the duty cycle, and RF signals are transmitted to the RFID reader for the other half of the duty cycle. This can lengthen processing time for the sensor device and RFID reader, since the sensor device can only receive power and communicate measurements for half of the duty cycle.

It would be beneficial to provide a sensor device that can continuously receive power and transmit measurement information in order to reduce processing times.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 schematically illustrates a sectional view of an example fluid fitting for a fluid element;

FIG. 2 schematically illustrates a sectional view of the fluid fitting in a pre-installed configuration;

FIG. 3 schematically illustrates a sectional view of the fluid fitting in a fully installed configuration;

FIG. 4 shows a perspective view a sensor device attached to the fluid fitting in the fully installed configuration; and

FIG. 5 is a schematic view of the sensor device and an external device;

FIG. 6 is a schematic view of a system that includes a plurality of fluid fittings and sensor devices;

FIG. 7 is another embodiment of the sensor device wherein the solar panel has been replaced with an RF antenna;

FIG. 8 is top view of another embodiment of the sensor device, wherein the circuit assembly, solar panel, and antenna are embedded within an overmolded housing; and

FIG. 9 is a bottom view of the sensor device of FIG. 8.

### DESCRIPTION OF EXAMPLE EMBODIMENTS

1Example embodiments are described and illustrated in the drawings. These illustrated examples are not intended to be a limitation on the present invention. For example, one or more aspects can be utilized in other embodiments and even other types of devices. Moreover, certain terminology is used herein for convenience only and is not to be taken as a limitation. Still further, in the drawings, the same reference numerals are employed for designating the same elements.

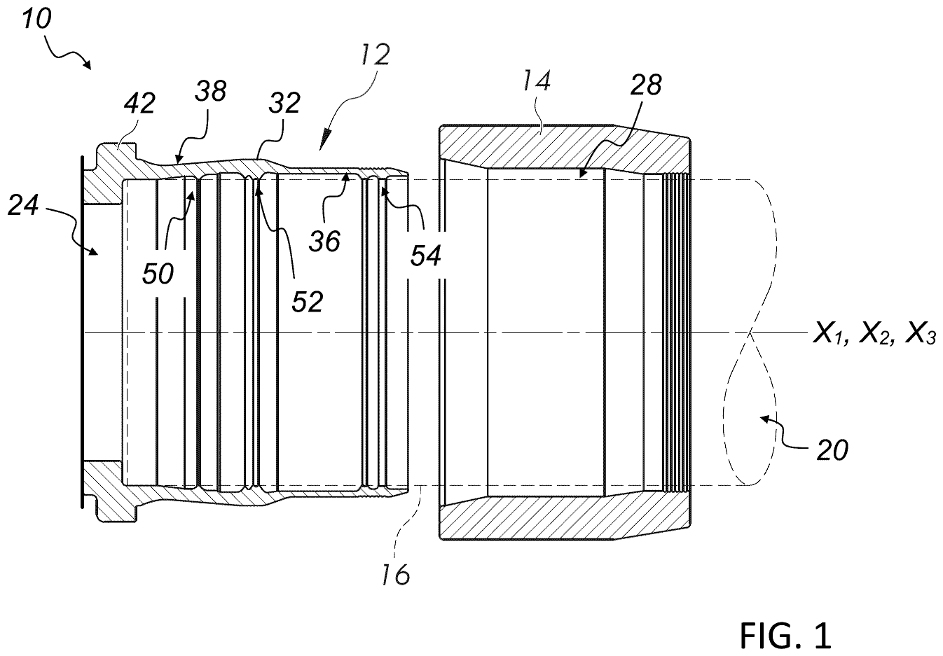

1Turning to the shown example of FIG. 1, an example fluid fitting 10 includes a coupling body 12 and a drive ring 14, which together can be utilized to join a fluid element 16 to the fluid fitting 10. The fluid element 16 in the present example is a pipe defining a passageway 20 for conveying fluid. Moreover, the coupling body 12 defines a bore 24 that can receive the fluid element 16 therein to place the coupling body 12 and fluid element 16 in fluid communication with each other. Meanwhile, the drive ring 14 defines a through hole 28 that, as discussed further below, can accommodate the coupling body 12 therein to mechanically attach the coupling body 12 to the fluid element 16 in a non-leaking manner.

The passageway 20, bore 24, and through hole 28 of the components 12, 14, 16 have respective central axes X₁, X₂, X₃. It is to be appreciated that the features of each component 12, 14, 16 in the present embodiment generally extend circumferentially and symmetrically about the component's respective axis X₁, X₂, X₃. Moreover, the central axes X₁, X₂, X₃ are aligned to be coaxial with each other in FIGS. 1-3.

The fluid element 16 can be a thin-walled or thick-walled pipe, such as a pipe ranging in size from ¼″ NPS to 4″ NPS. In one embodiment, the fluid element 16 is one of a schedule 10 type pipe through a schedule 80 type pipe and has a wall thickness between about 0.057 inches to about 0.261. However, the fluid element 16 may have other pipe sizes in some examples. Broadly speaking, the fluid element 16 can be any structure that defines a passageway for conveying fluid. For instance, the fluid element 16 can be a tube, manifold, fluid connector, nozzle, or any combination thereof.

The coupling body 12 comprises a sleeve 32 having an inner surface 36 and an outer surface 38. The inner surface 36 of the sleeve 32 defines the bore 24 of the coupling body 12. Moreover, the coupling body 12 comprises a circumferential flange 42 that extends radially outward from the outer surface 38 of the sleeve 32. The flange 42 extends from the sleeve 32 in the radial direction and can be used by an external installation tool to join the fluid fitting 10 to the fluid element 16, as described later herein.

The sleeve 32 of the coupling body 12 includes a plurality of circumferential seals 50, 52, 54 formed by the inner surface 36, including an inboard or proximal seal 50, a main seal 52, and an outboard or distal seal 54. Each seal 50, 52, 54 can comprise one or more teeth that extend radially inward from neighboring portions of the inner surface 36 for sealing between and mechanically connecting the coupling body 12 to the fluid element 16.

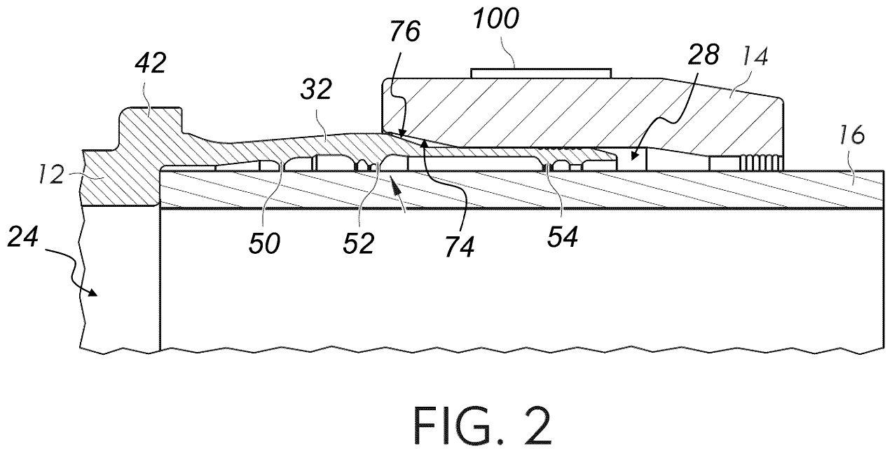

The coupling body 12 and drive ring 14 can be initially assembled in a pre-installed configuration as shown in FIG. 2. Specifically, the drive ring 14 can be arranged over the end of the coupling body 12 such that the central axes X₁, X₂ of the coupling body 12 and drive ring 14 are collinear and the coupling body 12 is arranged within the through hole 28 of the drive ring 14. In this configuration, a ramped-up section 74 of the drive ring 14 will be adjacent, but slightly spaced relative to, a land section 76 of the coupling body 12. Through an interference fit, the drive ring 14 can be maintained on the coupling body 12 in the pre-installed configuration and shipped to customers, which facilitates ease of use and installation by the ultimate end-users.

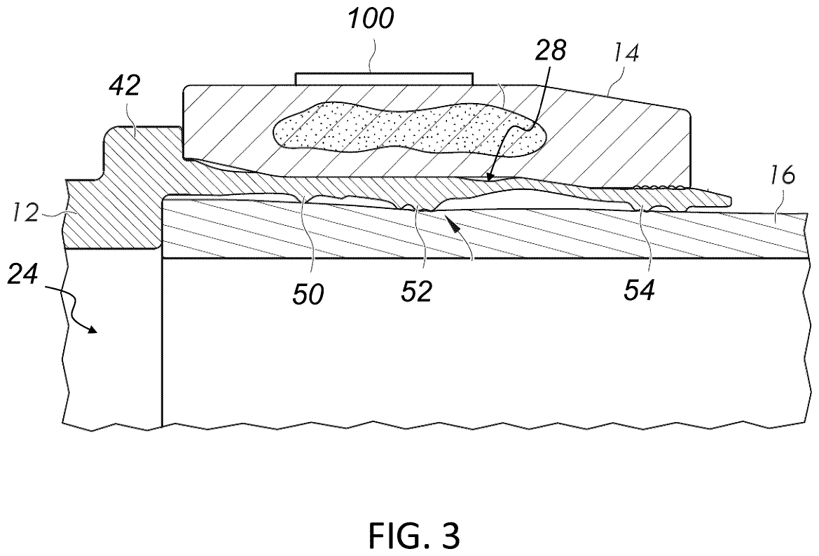

To install the fitting 10 onto a fluid element 16, the fluid element 16 can be located within the bore 24 of the coupling body 12 while the fitting 10 is in its pre-installed configuration (FIG. 2). An installation tool can then be used to axially force the drive ring 14 toward the flange 42 of the coupling body 12 until the fitting 10 assumes its installed configuration (FIG. 3). The drive ring 14 and coupling body 12 have a predetermined ratio of interference, such that axial movement of the drive ring 14 to the installed configuration causes the coupling body 12, drive ring 14, and fluid element 16 to deform, thereby creating a mechanical connection of these elements with a metal-to-metal seal between the fluid element 16 and coupling body 12.

More specifically, as the drive ring 14 is forced axially toward the flange 42, it applies a compressive force to the coupling body 12 that causes radial deformation of the body 12, forcing the tooth or teeth of its seals 50, 52, 54 to bite into the fluid element 16. The coupling body 12 in turn compresses the fluid element 16 first elastically (i.e., non-permanent) and then plastically (i.e., permanent). This compression is sufficiently high to plastically yield the fluid element 16 under the sealing lands, forming a 360°circumferential, permanent, metal-to-metal seal between the fluid element 16 and the coupling body 12. Simultaneous with the radial compression of the body 12 and the fluid element 16, the drive ring 14 expands radially outward. This radial expansion of the drive ring 14 is elastic, and results in a small increase in the diameter of the drive ring 14.

Once installed, the drive ring 14 will abut or engage the flange 42 (although it can be spaced from flange 42 in other examples). Moreover, because the drive ring 14 deforms elastically during installation such that it expands radially outward, the drive ring 14 will exert a continuous elastic force against the coupling body 12 and fluid element 16 that is maintained after installation through the life of the fitting 10, thereby preventing release of the metal-to-metal seal between the fluid element 16 and the coupling body 12.

Preferably, the stress within the drive ring 14 during installation never exceeds the elastic limit of the material forming the drive ring 14. In other words, the radial expansion of the drive ring 14 which occurs is well within the elastic limits of the material such that an elastic force is maintained against the coupling body 12 and the fluid element 16. For example, as the drive ring 14 is pushed onto the coupling body 12, the drive ring 14 can encounter a working stress of about 20,000 psi and elastically deform such that it expands by about 1.5 mil (1 mil equals 1 thousandth inch). This stress is indicated by strain, which can be measured by a sensor. Moreover, the measured strain can be indicative of a status of quality of the fitting 10. For instance, a low measured strain could indicate that the fitting 10 was not properly installed. Moreover, a significant drop in strain after the fitting 10 has been installed could indicate a potential failure of the fitting 10.

The fitting 10 as described above can comprise a variety of other configurations for mechanical attachment to a fluid element without departing from the scope of this disclosure. Various example fittings with coupling bodies and drive rings are described in commonly owned U.S. Pat. Nos. 10,663,093; 8,870,237; 7,575,257; 6,692,040; 6,131,964; 5,709,418; 5,305,510; and 5,104,163, which are all expressly incorporated herein by reference in their entirety. Broadly speaking, the fitting 10 can comprise any configuration that enables the fitting 10 to be fluidly coupled to one or more fluid elements, particularly wherein one or more components of the fitting 10 experience deformation or other physical changes that can be measured by a sensor.

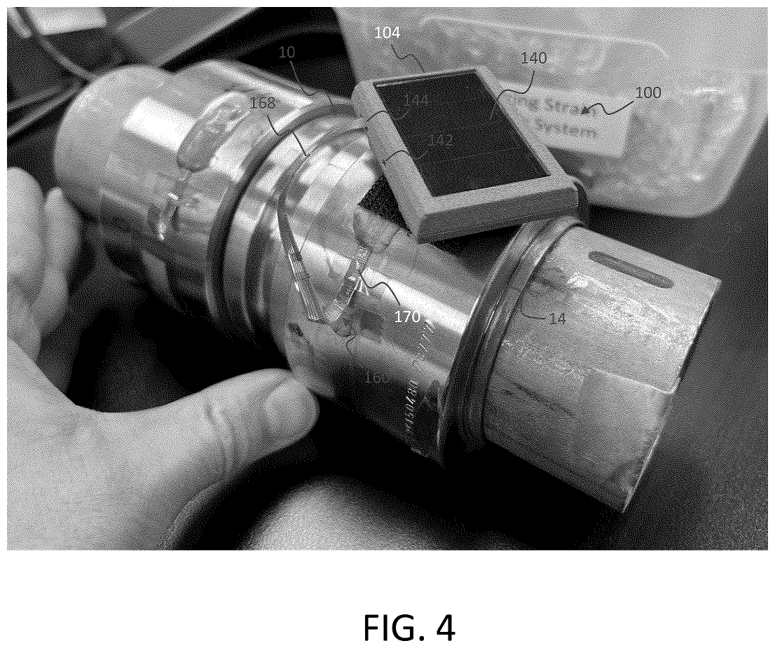

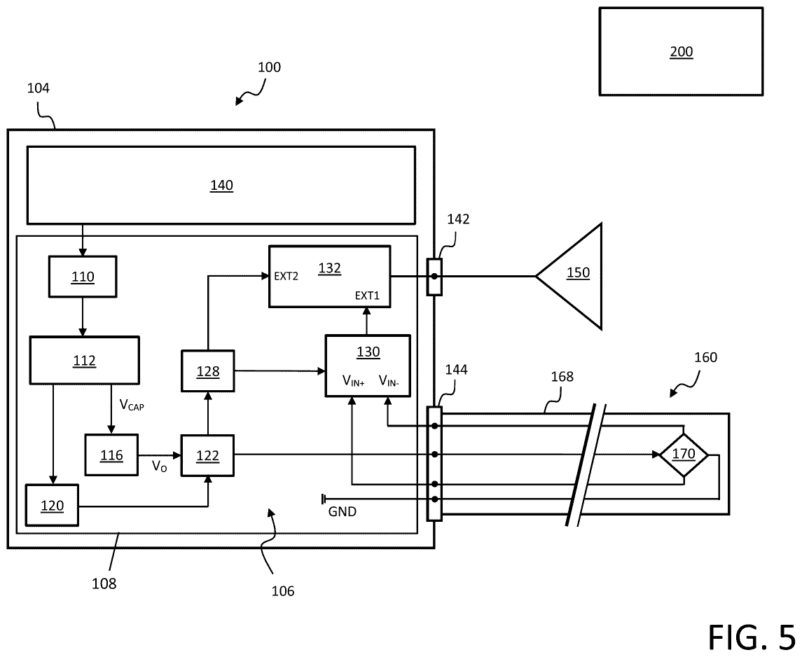

Turning to FIGS. 4 and 5, a sensor device 100 will now be described that can be affixed to the fitting 10 and is operable to measure one or more parameters of the fitting 10. FIG. 4 shows a perspective view of the sensor device 100 affixed to the drive ring 14 of the fitting 10, while FIG. 5 shows a schematic view of the sensor device 100 and its components.

The sensor device 100 includes a housing 104 that contains and supports a circuit assembly 106 (see FIG. 5) for the device 100. The circuit assembly 106 includes a circuit board 108 and various components supported by the circuit board 108 such as, for example, a first regulating unit 110, a charge storage unit 112, a second regulating unit 116, a regulator control unit 120, a regulator switching unit 122, an intermediate voltage unit 128, a sensor conditioning unit 130, and a transmitter chip 132.

The device 100 further includes a solar panel 140, a first electrical port 142, and a second electrical port 144 that are supported by the housing 104 and electrically coupled to the circuit assembly 106. The solar panel 140 comprises one or more photovoltaic cells that are exposed to light outside of the housing 104 and are configured to convert the light to electrical energy, which in turn can be delivered to the regulating unit 110 of the circuit assembly 106. The first electrical port 142 and/or the second electrical port 144 can include permanent or removable electrical connections between the circuit assembly 106 and external device(s).

The device 100 further includes an antenna 150 (omitted in FIG. 4) that is connected to the first electrical port 142 and operable to communicate wirelessly with an external device 200 (e.g., networking hub, computer server database, handheld reader/RF interrogator, etc.). The antenna 150 in the present embodiment is configured as a Bluetooth antenna for use with the Bluetooth communication protocol. In other examples, the antenna 150 may be a Wi-Fi or RF antenna. Further, the external device 200 preferably has a programmable microprocessor that can include various features and capabilities. For example, the microprocessor includes a programmable computing core that is capable of any or all of processing commands, making calculations, tracking/reading data, storing data, analyzing data, adjusting/manipulating data, receiving new commands or instructions, etc.

Lastly, the device 100 includes a sensor assembly 160 connected to the second electrical port 144 that includes a flexible cable 168 and a sensor 170 affixed to a distal end of the cable 168. In the present example, the sensor 170 corresponds to a strain gauge, which can be directly attached to a surface of the fitting 10 to measure strain therein.

Generally, a strain gauge measures a change in distance between two active spots, and so can be used to detect the changes in the drive ring 14 or coupling body 12 that result from installation of the fitting 10 upon the fluid element 16. A strain gauge, sometimes referred to as a strain transducer, for metallic structures is typically a metal film resistance device. In one example, a strain transducer can be attached to a metal diaphragm that bends (strains) as a result of applied stress (resulting from material expansion or contraction) in the object being measured. These transducers typically produce a small electrical resistance change in response to the movement (strain) of the structure to which they are attached, which is often metal. Still, the strain sensor 170 could indicate sensed strain by a change in impedance, conductivity or other detectable characteristic or condition.

Various other types of strain sensors could be used for the sensor 170, including semiconductor strain gauges (sometimes called piezoresistors), capacitive strain gauges, etc. Moreover, the sensor 170 can be configured to detect other physical parameters of the fitting 10 or fluid flowing therethrough, such as, for example, acceleration, vibration, temperature, flow rate, fluid velocity, fluid pressure, etc. Still further, the sensor device 100 may include additional and/or alternative sensors that are configured to detect additional and/or alternative properties. Indeed, the sensor device 100 can include any configuration of one or more sensors, wherein each sensor is configured to detect a property of the fitting 10. Moreover, the various types of sensors 170 can be interchangeably electrically connected to the circuit assembly 106 via the second electrical port 144.

As shown in FIG. 4, the sensor device 100 can be affixed to the drive ring 14 of the fitting 10. In particular, both the housing 104 and sensor 170 of the device 100 can be adhered to an external surface of the drive ring 14, such that solar panel 140 is exposed to ambient light and the sensor 170 can measure strain in the drive ring 14. However, in other examples, the sensor device 100 may be affixed to other portions of the fitting 10 such as the coupling body 12. It is to be appreciated that the solar panel 140 can generate electricity from the ambient light within the environment where the sensor device 100 is installed, or optionally, from light actively and temporarily supplied by a technician in the case of a dark environment.

Electrical energy generated by the solar panel 140 is fed to the first regulating unit 110 of the circuit assembly 106 in the form of a DC output. The regulating unit 110 in turn regulates and isolates the charge, and then supplies the regulated charge to the charge storage unit 112. Specifically, the regulating unit 110 may comprise one or more resistors for regulating the current. In addition or alternatively, the regulating unit 110 may comprise one or more diodes to prevent back current to the solar panel 140, which could damage the solar panel 140 and cause unstable operation. In certain embodiments, the regulating unit 110 may be omitted, so that the DC output of the solar panel 140 feeds directly to the charge storage unit 112.

The charge storage unit 112 may comprise a single capacitor or a bank of capacitors, with a combined output voltage V_{CAP}. The bank of capacitors may be in the form of a capacitor network, and the capacitors may be connected to each other in parallel or in series. Charge accumulates in the charge storage unit 112 as long a charge is being supplied thereto, until the charge storage unit 112 is at or near a fully charged state. When charge is drained from the charge storage unit 112 due to a sensor measurement being taken, the capacitor bank will subsequently recharge as long as a charge continues to be supplied thereto. In other words, the charge storage unit 112 continues to charge during operation until full.

The charge storage unit 112 produces, at its output, a harvested voltage V_{CAP}. Once the charge storage unit 112 has accumulated sufficient charge, the harvested voltage V_{CAP} is clamped to an optimum voltage by the second regulating unit 116, which takes the harvested voltage V_{CAP} as an input, and outputs a stable voltage, V_{O}.

Due to power requirements of the strain sensor 170, it has been found to be advantageous to leave power to the strain sensor 170 off until the charge storage unit 112 is sufficiently charged. Accordingly, the regulator control unit 120 monitors the charge storage unit 112 and activates the regulator switching control 122 when the charge storage unit 112 is sufficiently charged. For example, the regulator control unit 120 may compare V_{CAP} to a first predefined threshold, such as 0.9V. Only when V_{CAP} reaches the first threshold, can the regulator control unit 120 cause the sensor 170 to be turned on.

The output V_{O} of the regulating unit 116 is sufficiently stable to conduct very precise measurements such as strain gauge measurements. However, the power requirements of the strain sensor 170 can quickly drain the storage unit 112. To prevent the strain sensor 170 from unnecessarily consuming power, it has been found to be advantageous to disconnect the strain sensor 170 through the regulator switching unit 122 when measurements are not being made.

Accordingly, the regulator control unit 120 compares the output voltage Vo to a second predefined threshold, such as 1.9V for example, and only enables the regulator switching unit 122 when the second threshold has been reached and when a measurement of the strain sensor 170 is required. The regulator switching unit 122 may be implemented as a transistor that switches off when the output voltage Vo falls below the second predefined threshold, thus preventing the output voltage Vo from being put through to supply the strain sensor 170 when the output voltage Vo falls below the second predefined threshold. When the regulator switching unit 122 is switched on, the voltage V_{REF} is fed to the strain sensor 170.

The sensor conditioning unit 130 may require an indeterminate voltage, sometimes called a ‘floating’ voltage, for proper operation. Accordingly, the intermediate voltage unit 128 is configured to apply such a voltage to the sensor conditioning unit 130. This floating voltage may appear as an offset voltage on the output of the sensor conditioning unit 130. The intermediate voltage is also provided to the EXT2 A/D input of the transmitter chip 132 where it may be used to compensate the voltage reading on EXT1 A/D of the transmitter chip 132 which may contain an offset voltage present in the sensor conditioning unit 130 output. The intermediate voltage is also provided as an indication of voltage stability.

This is accomplished as follows. When the regulator control unit 120 turns the regulator switching unit 122 on and the output voltage V_{O} is provided to the intermediate voltage unit 128, the intermediate voltage unit 128 then feeds a forwarded control signal through to the transmitter chip 132. The forwarded control signal may be read in on pin EXT2 as an A/D input, where certain values of the forwarded control signal within a range of possible values serve to indicate that the intermediate voltage unit 128 is stable, and therefore used to qualify the output of strain sensor 170. This provides a safeguard so that believable but false readings of the sensor 170 are not interpreted as valid readings.

From the output of the regulator switching unit 122, the strain sensor 170 produces strain measurements VIN+, VIN−, which are input to the sensor conditioning unit 130. The sensor conditioning unit 130 may filter and/or amplify the measured values VIN+, VIN− and/or apply an offset to them. The sensor conditioning unit 130 produces an output that is read into the transmitter chip 132 as an A/D input on pin EXT1. The sensor conditioning unit's amplified, increased dynamic range, and voltage adjusted input to the transmitter chip 132 can improve measurement accuracy by enabling operation near the center of the A/D range. Alternatively, the sensor conditioning unit 130 can adjust the operation to any desired range, such as a modified range that is offset from the center of the A/D range.

The digitized values of EXT1, representing a strain measurement, and EXT2, representing an indication of whether the measurement is valid, are packaged together, preferably along with an ID associated with the sensor device 100, and wirelessly transmitted to the external device 200 via the antenna 150. The external device 200 checks whether EXT2 is within range, thus indicating that the value of EXT1 represents a true strain measurement, and not merely a believable but false value. If EXT2 indicates that the measurement is valid, then EXT1 is saved or recorded, either locally on the external device 200 or at a system supervisory device in communication with the external device 200. Peripheral data such as a timestamp and other information associated with the reading may be saved as well. On the other hand, if the value of EXT2 indicates that the measurement is not valid, then the pair of inputs EXT1, EXT2 may be discarded, either by deliberate deletion or by allowing the data to be overwritten.

The sensor device 100 as described above can continuously receive power so long as the solar panel 140 is exposed to light. Moreover, the circuit assembly 106 of the sensor device 100 can harvest energy from the solar panel 140 and efficiently provide a boosted charge for operation of the strain sensor 170, such that the sensor device 100 can provide accurate readings even during periods in which the solar panel 140 is not generating a large amount of energy. Furthermore, because the sensor device 100 utilizes the solar panel 140 as a power source, the antenna 150 can be used solely for data transmission (i.e., 100% duty cycle) rather than having to use the antenna 150 according to a reduced duty cycle that alternately receives energy (e.g., RF signals) and transmits data (i.e., 50% duty cycle). In other words, the antenna 150 can continuously transmit data while the solar panel 140 continuously and simultaneously generates energy for the sensor device 100. Thus, processing time for the sensor device 100 can be reduced as compared to other devices that must alternately receive energy and transmit data according to a duty cycle.

Still further, the antenna 150 of the present embodiment is a Bluetooth antenna. Accordingly, the antenna 150 can communicate wirelessly with external devices for farther distances (i.e., up to 30 meters) than an RFID antenna (i.e., only 0.5 meters). Similar benefits can be realized in embodiments wherein the antenna 150 is configured for WiFi communication. Nevertheless, the antenna 150 may be configured for other types of wireless transmission in other examples, including RF.

The components of the sensor circuit 106 are preferably implemented with analog components. In general, digital components consume relatively more power than analog components when properly implemented and therefore digital components may not be as well suited for instances in which the solar panel 140 is generating a low amount of energy. However, portions of the circuit 106 such as the transmitter chip 132 may be partially implemented in digital logic at the discretion of the circuit designer. Similarly, other components of the circuit 106 such as the regulator switching unit 122 may produce binary outputs (ON/OFF). Specifically, the regulator switching unit 122 may be implemented with transistors to confine its output voltage to only two predefined levels, corresponding to the output being either ON or OFF.

In addition to being able to monitor strain, the techniques disclosed herein may be applicable to many other types of sensors such as pressure transducers, highly accurate temperature sensors such as RTDs (resistance temperature detectors), thermistors, proximity sensors, humidity sensors, light detectors (photo cells) and the like. In these embodiments the strain sensor 170 can be replaced with the other sensor with minor changes in the circuitry and packaging.

The sensor device 100 can be used to identify any or all of properties, statuses, and conditions of the fluid fitting 10, as well as a quality of the attachment between the fluid fitting 10 and the fluid element 16. The use of the sensor device 100 is especially useful during an installation procedure of the fluid fitting 10 upon a fluid element 16 to indicate that the seal is complete (i.e., fully set) and that an acceptable pull-up has occurred. In this manner, the use of the sensor device 100 to obtain real-time data may reduce or remove the need for post-installation inspections.

It is contemplated that the sensor device 100 can be affixed to various parts of the fitting 10, interior or exterior, including the coupling body 12 and drive ring 14. The sensor device 100 could also be coupled to the fluid element 16, either internally or externally, and could potentially be exposed to the fluid carried by the fluid element 16. It is contemplated that the sensor device 100 could be located variously upon the fluid element 16, although a location relatively closer to the installed fitting 10 (such as directly adjacent) is preferable.

Stress or stain loading in the fluid element 16, which may be caused by the weight of fluid carried within the fluid element 16, or the installation load of the fluid element 16 depending upon how the fluid element 16 is installed or the structural loads applied to it, may be readily represented by detectable strain in the fluid element 16. Such a sensor device 100 located next to the fitting 10 can be used to understand or extrapolate the amount of stress or strain being realized by the fitting 10 when the fluid element 16 loading, which can help to indicate the condition or expected/forecasted condition of the seal integrity maintained by the installed fitting 10. In one example, at least one exterior surface of the sensor device 100 has a flexible, single-sided adhesive for attaching the sensor device 100 to the exterior of the drive ring 14. Alternatively, an externally-applied adhesive or the like can be used.

Due to the swaging action at installation, the sensor device 100 may not be installed on the interior of the drive ring 14 or the exterior of the body 12 at locations where these two surfaces interfere, because the sensor device 100 would likely be crushed, impacted, sheared, etc. Still, it may be possible to locate the sensor device 100 at non-interfering locations, or even at an interfering location if the sensor 170 is placed in a pocket, recess, or other protected location.

It is further contemplated that other identification data can be transmitted, recorded, or otherwise stored at the time of each sensor reading. For example, a time date stamp for the reading, a unique and application code, ambient environment temperature, temperature of the drive ring 14, other environmental factors, etc., can be sensed, transmitted, and/or stored. Other information can be recorded and/or captured about the fitting 10 itself, such as the type of fitting 10, the composition of the material, the intended use (e.g., pipe characteristics or field environment), etc. This type of contextual information can be used to provide a more tailored data analysis with respect to the raw data obtained from the sensor device 100.

In addition, it is contemplated that a strain reading can be taken for the drive ring 14 immediately prior to installation upon the fluid element 16 (i.e., prior to application of a compressive force on the fitting 10). This can be considered a first electrical parameter that provides a baseline reference point strain of the drive ring 14 at the ambient environment where it will be installed. Additionally, the act of applying the strain sensor 170 to an object, such as the drive ring 14, may induce or register some stress upon the strain sensor 170 itself. Thus, an initial strain reading of the drive ring 14 in the non-installed condition can provide a reference point for which to compare the ultimate strain reading at the installed condition. It is further contemplated that the reference point strain reading of the non-installed condition can be used to set a tare or zero point for the strain sensor 170. This zero point can be done in software, such as in the external device 200 or in the integrated circuit of the sensor device 100. For the purpose of future strain readings, it is contemplated that the initial strain sensor reading, or zero point, can be stored or otherwise written into the memory of the integrated circuit of the sensor device 100.

Next, after installation of the drive ring 14 upon the fluid element 16 (i.e., after to application of a compressive force on the fitting 100), the sensor device 100 can be used to take another strain reading. This can be considered a second electrical parameter produced by the sensor device 100 in response to the elastic deformation of the drive ring 14. The first electrical parameter (i.e., pre-install) can then be compared against the second electrical parameter (i.e., post-install) to obtain a final value indicative of the quality of the non-leaking attachment between the fluid fitting 10 and the fluid element 16. As will be discussed more fully herein, the final value can be compared against one of a predetermined range, a tolerance band, or a threshold in order to determine the quality of the non-leaking attachment. In this manner, the manufacturer, end-user, and quality control personnel can have a high degree of confidence that the seal is complete (i.e., fully set) and that an acceptable pull-up has occurred.

Thereafter, it is further contemplated that future, periodic strain sensor readings can be taken from the sensor device 100 as desired to provide an ongoing history of the health and condition of the drive ring 14 at the installed condition (to sense changes in stress due to age, usage, fluid in the pipe, mechanical forces upon the attached fitting or pipe, or other factors such as pressure, temperature, vibration, etc.). More broadly, the strain reading of the drive ring 14 can be used to extrapolate the condition of the installed fluid fitting 10 upon the fluid element 16 extending over its useful lifetime in the field so that the end-user has a high confidence of understanding how the installed fitting 10 is aging “under the hood.” Due to the wireless nature of the sensor device 100, such future periodic sensor readings can be obtained in a quick and efficient manner without need to interrupt operation of the fluid element 16 in its intended field use, even if the fluid element 16 is hidden or otherwise difficult to access.

In addition to obtaining and storing the sensor reading, either the external device 200 and/or possibly the sensor device 100 could include computer programming for data analysis and/or comparison. While a raw data reading for the sensed strain of the drive ring 14 is useful, it can be beneficial to provide the end customer with an indication as to whether or not the sensed strain is within a predetermined, acceptable range that indicates that the fluid fitting 10 is installed correctly for its intended purpose, and its health and condition is acceptable. In one example, the external device 200 could be programmed with an acceptable range of sensed strain readings, such as a predetermined tolerance band of acceptable readings, and can compare the data from the installed sensor device 100 against the predetermined range, tolerance band, or threshold(s). If the data reading from the sensor device 100 is within the acceptable range, the external device 200 can indicate so on a display or other user feedback device. On the contrary, if the data reading from the sensor device 100 indicates that the fluid fitting 10 is not installed correctly, the external device 200 can likewise indicate this information to the end-user so that they can perform corrective action.

Along these lines, such comparison and/or data analysis can be done over the lifetime of the installed fluid fitting 10 so that the end customer has a continuing high confidence that the installed fluid fitting 10 is still operating within design parameters. Alternatively, if the periodic, future sensed readings indicate that the fluid fitting 10 is trending out of bounds (e.g., an acceptable reading that is increasingly heading towards or becoming an unacceptable reading), or has exceeded a predetermined threshold (e.g., an unacceptable reading), the end customer can be informed that they should repair or replace the fluid fitting 10 prior to a potential failure. In this manner, the sensor device 100 can be used to determine predictive failure before any actual problems occur in the fluid fitting 10 and/or fluid element 16, so that corrective action can be taken. It is contemplated that the data analysis can take into consideration contextual information, such as the type of fitting, the composition of the material, the intended use (e.g., fluid element 16 characteristics or field environment), etc. for determining predetermined acceptable range(s) or threshold(s).

It is further beneficial to have the sensor readings obtained from the sensor device 100 transmitted or otherwise uploaded to a remote central computer server database (e.g., a network-connected or internet-connected computer, sometimes referred to as “in the cloud”), either directly or via the external device 200. The computer server database could be local to the site of the field installation or the controlling company, local to the manufacturer of the fluid fitting 10, and/or could be “cloud-based” in that it is maintained at a remote, internet-connected server. Such a “cloud-based” internet-connected server could provide data storage and retrieval capabilities, and/or may further provide computational capabilities to transform, analyze, and/or report upon the cataloged data. Moreover, in some examples, the external device 200 can correspond to the computer server database. Regardless of location, the computer service database can be maintained by the manufacturer of the fluid fitting 10, by a service company that inspects the fittings, and/or by the end user of the fluid fitting 10 for use by the associated quality assurance personnel.

In one example, the initial data from the sensor device 100 and associated fitting 10 can be captured by the manufacturer prior to the product leaving the warehouse, so that the manufacturer has a clear understanding of the state of the fluid fitting 10 and sensor device 100 prior to installation. This data can be uploaded to the computer server database for future use. Various examples of this data can include information about the fluid fitting 10 or sensor 170, such as a unique identifier of the sensor device 100, date of manufacture of the fitting 10, fitting type, material, customer, intended environment, etc.

The computer server database (i.e., the “cloud”) can store, analyze, transform, and report on various types of data, including some or all of historical strain readings, comparison of strain readings (current vs. historical), minimums/maximums, data offsets, calculations, etc. With regards to reporting, it is contemplated that the computer server database can be passive, in that the data and/or reports may be compiled but the user ultimately takes action based upon the data, or can be partially or wholly active, in which the computer server database can take further steps such as preemptively report potential problems to the manufacturer, end-user, service company, etc. based upon an analysis of the data input. Such active operation can be partially or fully automatic.

The use of a computer server database is also useful to enable dynamic readings and post-process analysis, based upon changing information. For example, although the term “the external device 200” is used herein for simplicity, it is understood that in actual practice it is unlikely that there will only be a single external device 200 device that will take readings from all sensor devices in the field. Indeed, it is more likely that each particular sensor device will be interrogated by multiple different external devices during its active lifetime. Thus, by storing the captured data in a central, remote computer server database, it does not matter which particular external device 200 is used. Because the data is stored remotely, which may include calibration data stored in associated with the unique identifier of each sensor device, the external device 200 may not need any prior information about the particular sensor device being read. For example, prior to taking a strain reading, the external device 200 may obtain the specific calibration data for an individual sensor device from the computer server database (if the calibration information is not available from the sensor device itself). The specific calibration data can be obtained by a lookup procedure based upon the unique identifier of the sensor device. Then, when the sensor device 100 transmits a reading (i.e., an electrical parameter) that is received by the external device 200, the transmitted electrical parameter can be corrected by applying the previously retrieved calibration data.

In another example, it is possible that the thresholds, tolerance bands, or predetermined boundaries for acceptable range that indicate that the fluid fitting 10 is installed correctly for its intended purpose may change over time. This may occur for various reasons, including further research and development, a better understanding of lifetime performance of the fluid fittings in different environments, changes in manufacturing, etc. Through the use of a cloud computing environment, the thresholds, tolerance bands, or predetermined boundaries can be easily changed in the computer server database and automatically applied to the data for past, present (real-time), or future strain readings. For example, based upon experience it may be determined that a performance threshold is too low or too high; thus, by changing the threshold in a single computer server database, it can be quickly applied across all past, present (real-time), or future strain readings. Similarly, based upon industry or customer demand, unique or different thresholds, tolerance bands, or predetermined boundaries can be applied to only a subset of products (i.e., only certain products of a particular customer or industry), which may change from time to time.

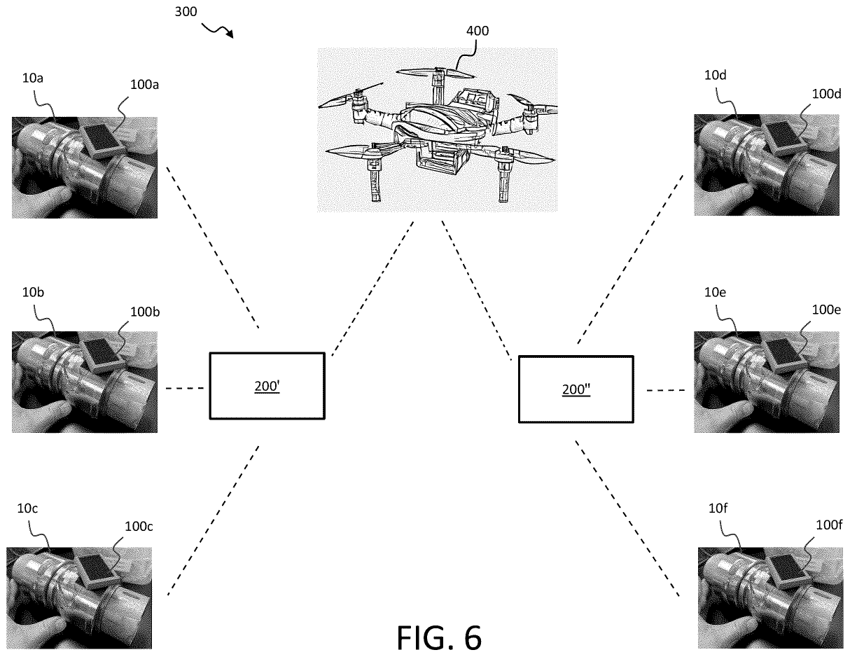

Turning to FIG. 6, an example system 300 is shown that includes a plurality of first fittings 10a-c and a plurality of first sensor devices 100a-c that are each affixed to an associated first fitting 10a-c. The system 300 further includes a plurality of second fittings 10d-f and a plurality of second sensor devices 100d-f that are each affixed to an associated second fitting 10d-f. The fittings 10a-f and sensor devices 100a-f respectively correspond to the fitting 10 and sensor device 100 described above.

The system 300 further includes a first external device 200′ that can communicate wirelessly with all of the first sensor devices 100a-c, and a second external device 200″ that can communicate wirelessly with all of the second sensor devices 100d-f. Each external device 200′, 200″ is a central hub that can receive sensor measurements (i.e., via Bluetooth) from each of its associated plurality of sensor devices 100a-c, 100d-f and then wirelessly broadcast the collective data (e.g., via Wifi, Bluetooth, NFC, cellular, or other similar techniques), such that a moving vehicle 400 can receive and store the collective data when in sufficient proximity to the external device 200′, 200″. The moving vehicle 400 in the present embodiment is a drone (e.g., a quadcopter or the like), although it may comprise other types of human operated or autonomous ground, water, or flying vehicles such as an automobile.

The system 300 described above thus enables the moving vehicle 400 to receive and store sensor measurements for a large number of fittings 10a-f arranged at various locations and distances from each other, even though each sensor device 100a-f generates relatively low power and may only be capable of wirelessly transmitting sensor measurements a short distance. For example, a factory could include a large number of fittings 10 and the moving vehicle 400 could periodically roam throughout the factory to collect the sensor data from some or all of the fittings 10. It is to be appreciated that number of fittings 10a-f, sensor devices 100a-f, and external devices 200′, 200″ may vary without departing from the scope of the disclosure.

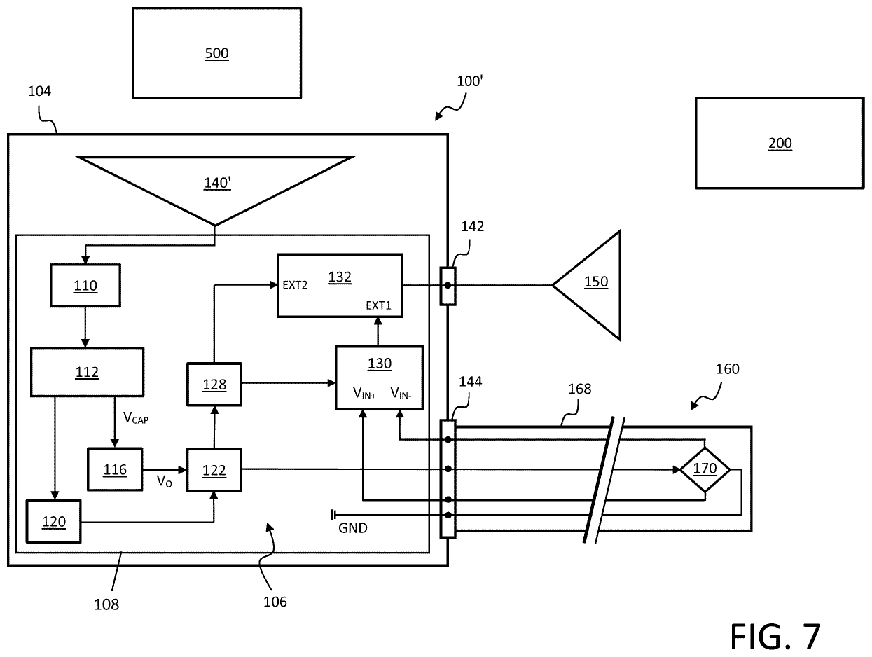

Turning to FIG. 7, another embodiment of the sensor device 100′ is illustrated, which is similar to the sensor device 100 described above except that the solar panel 140 has been replaced with an RF antenna 140′. In this embodiment, an RF transmitter 500 can be operated such that the transmitter 500 sends continuous or intermittent RF signals wirelessly to the RF antenna 140′ to power the sensor device 100′. Preferably, the RF signal is transmitted at a frequency in the range of 860-960 MHz, for example, at 915 Mhz. Notably, the sensor device 100′ will use its antenna 150 to transmit data to the external device 200 as described above, for example, using the Bluetooth or Wifi communication protocol. The RF transmitter 500 could be integrated with the external device 200, or separate therefrom. Accordingly, the RF transmitter 500 can be used solely for illuminating and powering the sensor device 100′ instead of both power transmission and data acquisition. In other words, the RF transmitter 500 can send/transmit RF signals to the RF antenna 140′ for 100% of its duty cycle to continuously power the sensor device 100′, thereby accelerating the power-up process of the sensor device 100′ (as compared to devices that use an RFID transmitter and RFID antenna for both power and data transmission) and/or enabling continuous sensor reading acquisition over an extended time period. It is further contemplated that the RF transmitter 500 could be used in a configuration similar to that shown in FIG. 6 herein, whereby a single transmitter could transmit RF signals to power multiple sensor devices either within a single location (i.e., a single room) or even via various locations via a moving vehicle.

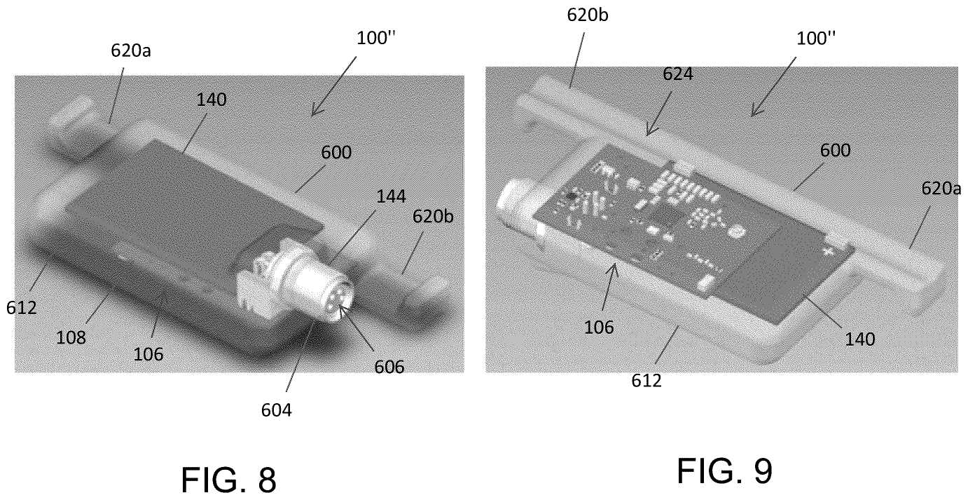

Turning to FIGS. 8 and 9, another embodiment of the sensor device 100″ is illustrated, wherein the circuit assembly 106, solar panel 140, and antenna 150 described above are embedded within an overmolded housing 600 comprising a light-transmissive (i.e., transparent or translucent) epoxy. In particular, the antenna 150 (not visible in FIGS. 8 and 9) is directly affixed to the circuit board 108 of the circuit assembly 106 and electrically connected to the transmitter chip 132 (e.g., via wiring or a conductive member of the circuit board 108), thereby eliminating the electrical port 142 in the first embodiment. Moreover, the electrical port 144 in this embodiment is a circular panel-mount connector that is mounted to the circuit board 108 and includes a male threaded portion 604 and a plurality of sockets 606 for receiving corresponding mating component of the sensor assembly 160. The overmolded housing 600 is formed by applying an epoxy resin such that the resin partially covers the electrical port 144 and completely covers the circuit assembly 106, solar panel 140, and antenna 150. The epoxy resin is then cured to form the housing 600.

The circuit assembly 106, solar panel 140, and antenna 150 will thus be fully embedded within the overmolded housing 600, thereby protecting those components from debris, impact, and the surrounding environment. Meanwhile, the electrical port 144 is partially embedded such that its male threaded portion 604 and sockets 606 are exposed and can be connected to a mating component of the sensor assembly 160. Moreover, because the housing 600 is light-transmissive, the solar panel 140 can still receive light and convert that light to electrical energy for the sensor device 100″.

The solar panel 140 thus permits application of an overmolded housing 600 that can encase and protect a majority of the sensor device components (e.g., the circuit assembly 106, solar panel 140, and antenna 150). In contrast, sensor devices that are battery operated typically require housing structures that can provide selective access to the battery (e.g., for replacement) and may not provide adequate protection/sealing from the outside environment.

In the embodiment shown in FIGS. 8 and 9, the housing 600 includes a main portion 612 that partially covers the electrical port 144 and completely covers the circuit assembly 106, solar panel 140, and antenna 150. The housing 600 further includes first and second arms 620a, 620b that extend from opposite sides of the main portion 612. Moreover, the underside of the housing 600 defines a channel 624 that extends across the main portion 612 and along both arms 620a, 620b. The sensor device 100″ can thus be installed on a fitting (e.g., the fitting 10 described above) by placing the housing 600 on the fitting such that its channel 624 is axially aligned with and receives the fitting. Each arm 620a, 620b can then be secured to the fitting with a strap that extends around the art 620a, 620b and fitting.

1The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A sensor device for a fluid fitting, the sensor device comprising:
a sensor assembly that is operable to measure a physical property of the fluid fitting;
an antenna that is operable to wirelessly transmit the physical property measured by the sensor assembly; and
a solar panel configured to convert light to electrical energy for the sensor and antenna,
wherein the sensor device is configured such that the antenna can wirelessly transmit the physical property measured by the sensor assembly while the solar panel simultaneously converts light to electrical energy for the sensor assembly and antenna.

2. The sensor device according to claim 1, wherein the antenna is a Bluetooth or Wifi antenna.

3. The sensor device according to claim 1, wherein the sensor assembly comprises a strain sensor.

4. The sensor device according to claim 1, further comprising a circuit assembly configured to receive energy generated by the solar panel and supply power to the sensor assembly.

5. The sensor device according to claim 4, further comprising a first electrical port and a second electrical port that respectively couple the antenna and sensor assembly to the circuit assembly.

6. The sensor device according to claim 5, wherein the sensor assembly comprises a flexible cable and a sensor affixed to the cable, wherein the cable is removably coupled to the second electrical port.

7. The sensor device according to claim 4, further comprising a housing that contains the circuit assembly, wherein the solar panel is affixed to the housing such that the solar panel is exposed to light outside of the housing.

8. The sensor device according to claim 7, wherein the housing is an overmolded housing that encapsulates the circuit assembly, solar panel, and antenna.

9. The sensor device according to claim 8, wherein the housing comprises a light-transmissive epoxy.
